(19) United States
(12) Patent Application Publication
(10) Pub. No.: US 2024/0192875 A1
(43) Pub. Date: Jun. 13, 2024

(54) REMAPPING BAD BLOCKS IN A MEMORY SUB-SYSTEM

(71) Applicant: MICRON TECHNOLOGY, INC., Boise, ID (US)

(72) Inventors: Yang Liu, San Jose, CA (US); Wenyen Chang, San Jose, CA (US); Wei Wang, Dublin, CA (US); Aaron Lee, Sunnyvale, CA (US); Jiangli Zhu, San Jose, CA (US)

(21) Appl. No.: 18/519,611

(22) Filed: Nov. 27, 2023

Related U.S. Application Data
(60) Provisional application No. 63/431,412, filed on Dec. 9, 2022.

(51) Int. Cl. G06F 3/06

(52) U.S. Cl. CPC G06F 3/064; G06F 3/0619; G06F 3/0679

(57) ABSTRACT

A system includes a memory device having a plurality of memory planes and a processing device operatively coupled with the memory device. The processing device to is perform operations including identifying a first block stripe of the memory device. The first block stripe includes a first plurality of blocks arranged across the plurality of memory planes. The operations further include determining that the first plurality of blocks of the first block stripe has greater than a threshold number of blocks associated with an error condition. Responsive to determining that the first plurality of blocks has greater than the threshold number of blocks associated with the error condition, the operations further include mapping a block of the first plurality of blocks associated with the error condition to a second block stripe including a second plurality of blocks having fewer than the threshold number of blocks associated with the error condition.

### RELATED APPLICATIONS

This application claims the benefit of U.S. Provisional Patent Application No. 63/431,412, filed Dec. 9, 2022, the entire contents of which are incorporated by reference herein.

### TECHNICAL FIELD

Embodiments of the disclosure relate generally to memory sub-systems, and more specifically, relate to remapping bad blocks in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with some embodiments of the present disclosure.

FIG. 1B is a block diagram of a memory device in communication with a memory sub-system controller of a memory sub-system, according to an embodiment.

FIG. 2 is a block diagram illustrating a memory sub-system implementing the remapping of bad blocks in a memory device in accordance with some embodiments of the present disclosure.

FIG. 3 is a block diagram illustrating a set of blocks in block stripes across a multi-plane memory device in accordance with some embodiments of the present disclosure.

FIG. 4 schematically illustrates an example bad block remapping table in accordance with some embodiments of the present disclosure.

FIG. 5 is a flow diagram of an example method to remap bad blocks in a memory sub-system in accordance with some embodiments of the present disclosure.

FIG. 6 is a flow diagram of an example method to remap bad blocks in a memory sub-system in accordance with some embodiments of the present disclosure.

FIG. 7 is a flow diagram of an example method to generate a bad block remapping table in accordance with some embodiments of the present disclosure.

FIG. 8 is a block diagram of an example computer system in which embodiments of the present disclosure may operate.

### DETAILED DESCRIPTION

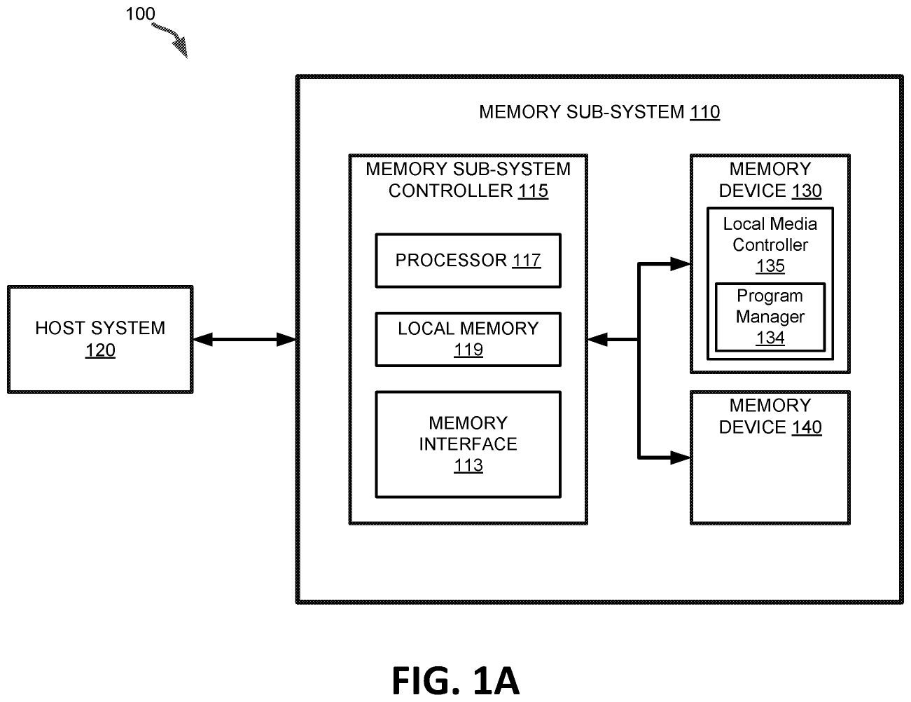

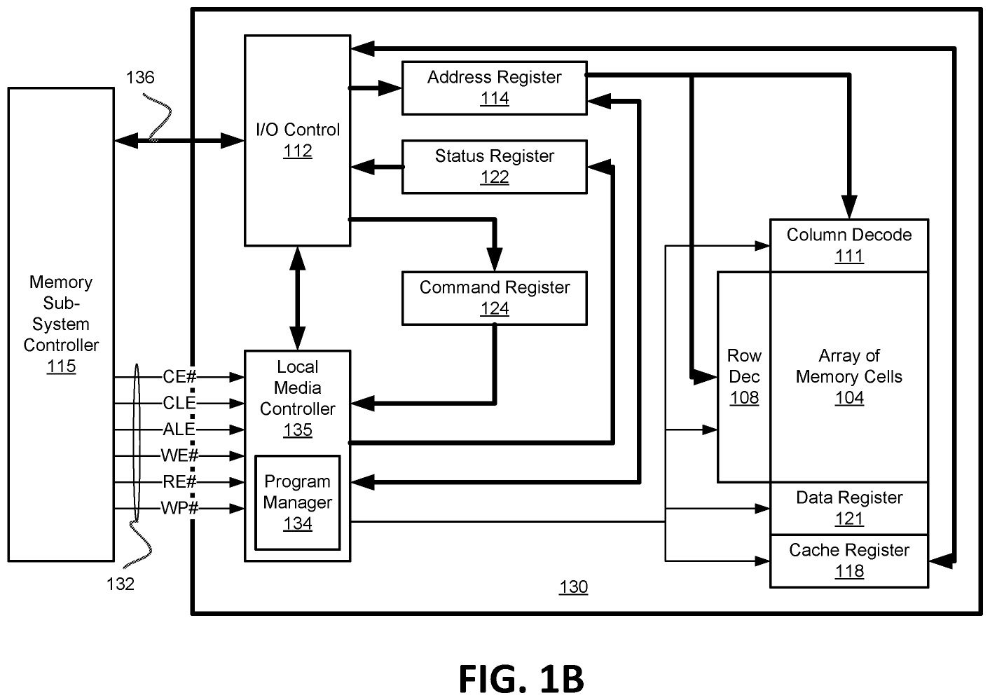

Aspects of the present disclosure are directed to remapping bad blocks in a memory sub-system. A memory sub-system can be a storage device, a memory module, or a combination of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1A. A non-volatile memory device is a package of one or more dies. Each die can consist of one or more planes. For some types of non-volatile memory devices (e.g., NAND devices), each plane consists of a set of physical blocks. Each block includes a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A die is also referred to as a logical unit (LUN). A LUN can contain one or more planes. A memory sub-system can use a striping scheme to treat various sets of data as units when performing data operations (e.g., write, read, erase). A LUN stripe is a collection of planes that are treated as one unit when writing, reading, or erasing data. Each plane in a LUN stripe can carry out the same operation, in parallel, of all the other planes in the LUN stripe. A block stripe is a collection of blocks, one from each plane in a LUN, that are treated as a unit. The blocks in a block stripe have the same identifier(s) that associates the blocks to the block stripe (e.g., block number, block stripe index, etc.).

A memory sub-system includes memory devices having bad blocks. A “bad block” herein refers to a block that is no longer reliable for storing or retrieving data, for example, due to a defect (e.g., manufacturing defect) or due to wear. A manufactured bad block (MBB) is unreliable due to such a defect and may already be listed in a bad block list (or look up table). A grown bad block (GBB) refers to a bad block being unreliable due to wear and can be identified based on a threshold. In some embodiments, for example, GBBs are identified as having one or more invalid bits whose reliability is not guaranteed. This level of reliability may be determined, for example, by the bad block dropping below a bit error rate (BER) threshold designated as the point of wear below which there exists unacceptable unreliability. Other ways of detecting a bad block include failure of the block to fully or properly be erased, failure to program the block, and/or failure to read data out of the block, e.g., attempting a read operation results in an uncorrectable data read error.

Due to non-uniformity and variation in a manufacturing process, the memory sub-system initially includes a small percentage of bad blocks (e.g., “factory error bad blocks”). In addition, good blocks (i.e., blocks that are not classified as a bad block and that can initially reliably store data) can become bad blocks (referred to as “grown bad blocks”) as blocks wear out during the lifetime of the memory sub-system and/or due to damage or defects of the memory cells. For example, during an erase operation, the data stored in one or more memory cells of bad blocks can fail to be properly erased. Accordingly, in the memory sub-system, bad blocks are not used to store data. Instead, the memory sub-system tracks bad blocks in order to avoid storing any data at the bad blocks. Therefore, the memory capacity of the memory sub-system can decrease as more blocks become unreliable and are thus not used for data storage.

More than a threshold amount of bad blocks in a block stripe can lead to poor or inconsistent performance. Some memory sub-systems may skip programming block stripes with more than a threshold amount of bad blocks. This practice can remedy inconsistencies introduced into the memory sub-system performance by the excessive number of bad blocks but at the expense of wasting block stripes. Because locations of bad blocks in a memory device are not random (e.g., bad blocks tend to be located near each other in the LUN), some systems form block stripes by assigning memory blocks at differing locations in the LUN to a block stripe in an attempt to dissociate the locality of the blocks (e.g., to decrease the likelihood of assigning neighboring bad blocks to the block stripe). For example, some systems assign different blocks on differing planes from different LUNs to a block stripe. This practice can alleviate problems caused by too many bad blocks in a block stripe by generally reducing the number of bad blocks per block stripe. However, some block stripes can include significantly more bad blocks than other block stripes. Performance of the memory sub-system can thus still be inconsistent.

Aspects of the present disclosure address the above and other deficiencies by remapping bad blocks in block stripes of a memory sub-system in order to increase the performance consistency of the memory sub-system. Accordingly, memory sub-systems operating according to aspects of the present disclosure can have a more consistent distribution of bad blocks amongst block stripes. In some embodiments, this is accomplished by identifying a block stripe having multiple blocks across multiple memory planes of the LUN. The block stripe may have a selected skew offset for offsetting the blocks assigned to the block stripe in relation to the memory planes of the LUN. For example, a block stripe may be made up of memory blocks in neighboring planes. The selection of memory blocks may be “skewed” so that the block stripe does not include memory blocks residing in the same corresponding position in neighboring planes. Instead, memory blocks are selected to be offset from one another in neighboring planes, creating a “skew” of memory blocks as described in more detail herein below. In some embodiments, software determines that the multiple blocks of the identified block stripe include greater than a threshold number of bad blocks. The threshold number may be related to the ratio of the total number of bad blocks in a memory sub-system to the number of block stripes in a memory sub-system. For example, the threshold number can be calculated using the ratio of the total number of bad blocks to the number of block stripes as described in more detail herein below. Responsive to determining that the block stripe has more bad blocks than the threshold number, software maps one or more blocks from the block stripe from their initial block stripe to another block stripe having fewer than the threshold number of bad blocks. Mapping bad blocks from one block stripe to another reduces the number of bad blocks of the first block stripe while increasing the number of bad blocks of the second block stripe. Thus, bad memory blocks are more evenly distributed amongst the block stripes, leading to an increase in performance consistency of the memory sub-system.

Advantages of the present disclosure include providing more consistent memory sub-system performance. For example, by evenly distributing bad blocks across block stripes on a LUN, sequential write operations are not hampered by seemingly random distribution of bad blocks that could otherwise occur. Because bad blocks are more evenly distributed across the block stripes, the memory sub-system is more likely to meet performance consistency benchmarks. Therefore, fewer manufactured memory sub-systems having errors (e.g., bad blocks) are thrown away, leading to greater manufacturing output. Additionally, performance of memory sub-systems according to embodiments described herein can have increased performance, leading to faster memory operations such as sequential write operations and decreased latency.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a memory interface component 113 that can handle interactions of memory sub-system controller 115 with the memory devices of memory sub-system 110, such as memory device 130. For example, memory interface component 113 can receive data from memory device 130, such as data retrieved in response to a read operation or a write operation. In some examples, the memory sub-system controller 115 can include a processor 117 (processing device) configured to execute instructions stored in local memory 119 for performing the operations described herein.

In some embodiments, memory device 130 includes a program manager 134 configured to carry out bad block remapping operations. In some embodiments, local media controller 135 includes at least a portion of program manager 134 and is configured to perform the functionality described herein. In some embodiments, the program manager 134 is part of the host system 110, an application, or an operating system. Further details with regards to the operations of program manager 134 are described below. In some embodiments, program manager 134 is implemented on memory device 130 using firmware, hardware components, or a combination of the above. In some embodiments, program manager 134 receives, from a requestor, such as the memory sub-system controller 115 (e.g., specifically, memory interface 113), a request to configure and/or generate (e.g., identify) one or more block stripes on a memory array (e.g., a LUN, etc.) of the memory device 130. In some embodiments, the program manager 134 can identify block stripes having more than a threshold number of bad blocks. The program manager 134 can further identify block stripes having fewer than the threshold number of bad blocks.

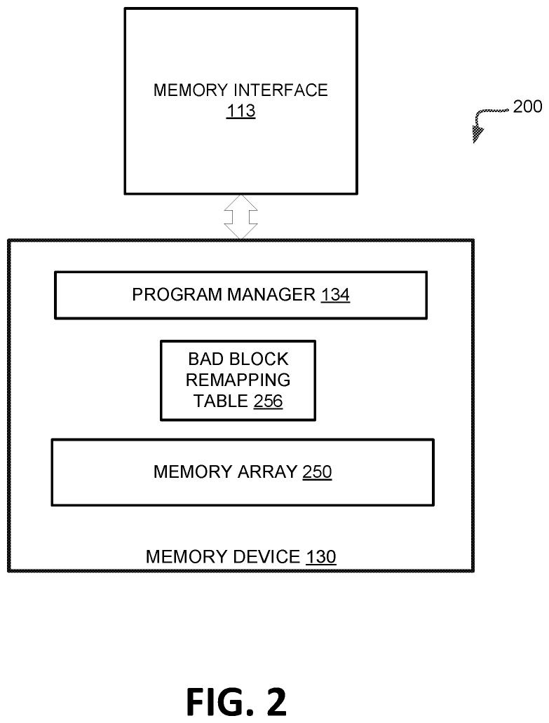

In some embodiments, the program manager can remap bad blocks from block stripes with more than the threshold number of bad blocks to block stripes having fewer than the threshold number of bad blocks. In some embodiments, the program manager 134 can store parameters associated with the mapping of the bad blocks in a data structure (e.g., bad block remapping table 256 in FIG. 2A and FIG. 2B) for later reference (e.g., by the memory interface 113, etc.) for servicing a data command such as a write command or a read command. For example, the parameters stored by the program manager 134 can include a block stripe index parameter identifying the bad block as having initially been mapped to another block stripe. In another example, the parameters can include an origination parameter identifying the bad block as initially belonging to a specific block stripe having more than the threshold number of bad blocks. In yet another example, the parameters can include a location parameter identifying the location of the remapped bad block in the memory array (e.g., the physical address of the remapped bad block).

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), can be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line can be associated with more than one logical row of memory cells and a single data line can be associated with more than one logical column. Memory cells (not shown in FIG. 1B) of at least a portion of array of memory cells 104 are capable of being programmed to one of at least two target data states.

Row decode circuitry 108 and column decode circuitry 111 are provided to decode address signals. Address signals are received and decoded to access the array of memory cells 104. Memory device 130 also includes input/output (I/O) control circuitry 112 to manage input of commands, addresses and data to the memory device 130 as well as output of data and status information from the memory device 130. An address register 114 is in communication with I/O control circuitry 112 and row decode circuitry 108 and column decode circuitry 111 to latch the address signals prior to decoding. A command register 124 is in communication with I/O control circuitry 112 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 111 to control the row decode circuitry 108 and column decode circuitry 111 in response to the addresses. In one embodiment, local media controller 135 includes program manager 134, which can implement the bad block remapping operations with respect to memory device 130, as described herein.

The local media controller 135 is also in communication with a cache register 118. Cache register 118 latches data, either incoming or outgoing, as directed by the local media controller 135 to temporarily store data while the array of memory cells 104 is busy writing or reading, respectively, other data. During a programming operation (e.g., a write operation), data can be passed from the cache register 118 to the data register 121 for transfer to the array of memory cells 104; then new data can be latched in the cache register 118 from the I/O control circuitry 112. During a read operation, data can be passed from the cache register 118 to the I/O control circuitry 112 for output to the memory sub-system controller 115; then new data can be passed from the data register 121 to the cache register 118. The cache register 118 and/or the data register 121 can form (e.g., can form a portion of) a page buffer of the memory device 130. A page buffer can further include sensing devices (not shown in FIG. 1B) to sense a data state of a memory cell of the array of memory cells 104, e.g., by sensing a state of a data line connected to that memory cell. A status register 122 can be in communication with I/O control circuitry 112 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) can be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands can be received over input/output (I/O) pins [7:0] of I/O bus 136 at I/O control circuitry 112 and can then be written into command register 124. The addresses can be received over input/output (I/O) pins [7:0] of I/O bus 136 at I/O control circuitry 112 and can then be written into address register 114. The data can be received over input/output (I/O) pins [7:0] for an 8-bit device or input/output (I/O) pins [15:0] for a 16-bit device at I/O control circuitry 112 and then can be written into cache register 118. The data can be subsequently written into data register 121 for programming the array of memory cells 104.

In an embodiment, cache register 118 can be omitted, and the data can be written directly into data register 121. Data can also be output over input/output (I/O) pins [7:0] for an 8-bit device or input/output (I/O) pins [15:0] for a 16-bit device. Although reference can be made to I/O pins, they can include any conductive node providing for electrical connection to the memory device 130 by an external device (e.g., the memory sub-system controller 115), such as conductive pads or conductive bumps as are commonly used.

In some implementations, additional circuitry and signals can be provided, and that the memory device 130 of FIG. 1B has been simplified. It should be recognized that the functionality of the various block components described with reference to FIG. 1B cannot necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) can be used in the various embodiments.

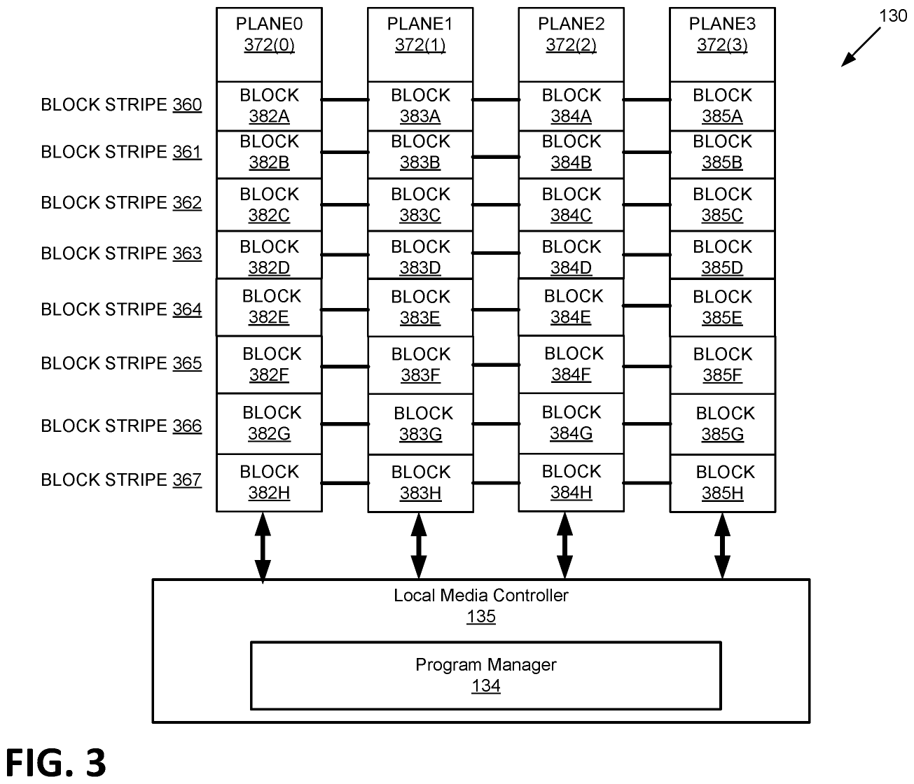

FIG. 2 is a block diagram illustrating a memory sub-system 200 implementing the remapping bad blocks in a memory device in accordance with some embodiments of the present disclosure. In one embodiment, memory device 130 is operatively coupled with memory device 130. In one embodiment, memory device 130 includes program manager 134, a bad block remapping table 256, and memory array 250, which is one example of the array of memory cells of planes 372(0)-372(3) illustrated in FIG. 3. Memory array 250 can include an array of memory cells formed at the intersections of wordlines and bitlines. In one embodiment, the memory cells are grouped into blocks, and the blocks are further grouped into block stripes across planes, e.g., block stripes 360-367 across planes 372(0)-372(3) in FIG. 3.

In some embodiments, the program manager 134 can generate (e.g., identify) the block stripes of the memory array 250 by grouping the blocks into the block stripes. The blocks may be grouped by indexing the blocks in a data structure such as a look-up-table that associates the blocks with discrete block stripes. In some examples, the program manager 134 can scan the memory planes of the memory array 250 to identify the bad blocks of the memory array 250. The scan operation may determine which blocks have a BER below a BER threshold, and/or to determine which blocks have not been fully or properly erased. Similarly, the scan operation may be to determine which blocks data cannot be read. In some embodiments, the bad blocks are associated with an error condition. For example, the bad blocks may have a BER above a BER threshold, may not be fully or properly erased, and/or cannot be read. The program manager 134 may assign the blocks to block stripes so that neighboring bad blocks are not included on the same block stripe. Blocks on a memory plane with a high density of bad blocks may be assigned to different block stripes. In some examples, the program manager 134 may assign blocks on differing memory planes to the same block stripe instead of assigning all blocks in a single plane to a block stripe.

In some embodiments, the program manager 134 may select a skew offset for a block stripe based on the scan performed above. The skew offset can be selected so that adjacent blocks in a block stripe physically reside at least a threshold distance away from each other in a LUN. For example, a first block in the block stripe may be in a first position in a first plane, a second block in the block stripe may be in a different second position in a second adjacent plane, and a third block in the block stripe may be in a different third position in a third adjacent plane. Each of the first position, the second position, and the third position may be offset by a selected distance (e.g., an offset by a number of memory blocks in the memory planes) so that the first, second, and third blocks are physically distanced away from each other. This can be referred to as the “skew offset.” The skew offset may determine the “offset” of planes for assignment of blocks to the block stripe (e.g., the skew offset is the physical distance between memory blocks of a block stripe that physically reside on adjacent planes). For example, with a skew offset of 1, a block stripe may include a first block of a first plane, a second block of a second adjacent plane, a third block of a third adjacent plane, and so on. In that same example, another block stripe may include a second block of the first plane, a third block of the second plane, a fourth block of the third plane, and so on. In another example, with a skew offset of 2, a block stripe may include a first block of a first plane, a third block of the second plane, a fifth block of a third and so on. In that same example, another block stripe may include a second block of the first plane, a forth block of the second, a sixth block of a third plane, and so on. The program manager can then map the blocks across the memory planes of the memory array 250 to the block stripes based on the skew offset.

After generating of the block stripes (e.g., identifying of the block stripes), the distribution of bad blocks amongst the block stripes may be inconsistent. In some embodiments, the program manager 134 may scan the generated block stripes to determine whether each block stripe has more or less than a threshold number of bad blocks. The threshold number of bad blocks may be calculated using the ratio of the total number of bad blocks to the total number of block stripes (e.g., in the memory array 250). The program manager 134 may classify the block stripes into groups based on results of the scan. For example, the program manager 134 may scan the block stripes and classify the block stripes into groups. In some examples, a first group of block stripes is made up of block stripes that have more than the threshold number of bad blocks. A second group of block stripes is made up of block stripes that have fewer than the threshold number of bad blocks. In some embodiments, the program manager 134 can map bad blocks from block stripes of the first group (having more than the threshold number of bad blocks) to block stripes of the second group (having fewer than the threshold number of bad blocks). Parameters and/or metadata associated with mapping the bad blocks from block stripes of the first group to block stripes of the second group (such as block indices, physical block addresses, block source identifiers, block destination identifiers, etc.) can be saved by the program manager 134 in the bad block remapping table 256. In some embodiments, the bad block remapping table 256 can be utilized when write and/or read commands are serviced. When a read or write command is called, the mapping parameters stored in the bad block remapping table 256 can be used to distinguish which blocks are assigned to a particular block stripe for executing the read or write command. For example, the memory interface 113 may utilize the bad block remapping table 256 to determine what blocks belong to a given block stripe when servicing a write command (e.g., a sequential write command). Performance consistency (e.g., consistent rate of data transfer) of the memory array 250 during data write or read commands may be increased by the remapping of bad blocks.

FIG. 3 is a block diagram illustrating a set of blocks in block stripes across a multi-plane memory device in accordance with some embodiments of the present disclosure. Each plane in the multi-plane memory device can include one or more block stripes. A block stripe is a collection of blocks, one from each plane, that are treated as a single unit. The blocks in a block stripe have the same block identifier (e.g., block number) in their respective planes.

In one embodiment of the present disclosure, the program manager 134 can identify a bad block located on a block stripe within a plane, e.g., block 382A of block stripe 360 within plane 372(0). The program manager 134 can also identify a replacement block located on a block stripe within a different plane from the identified bad block, e.g., block 384E of block stripe 364 of plane 372(2). The replacement block can be a block that is not associated with an error condition, i.e., a good block. In one embodiment of the present disclosure, the program manager 134 can replace the identified bad block with the replacement block. Parameters and/or metadata that map the replacement block to the block stripe can be stored in a look-up-table for servicing read and/or write commands as described herein.

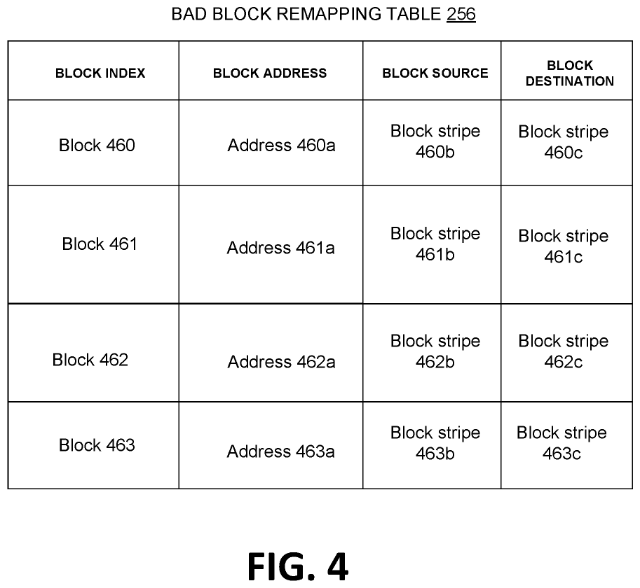

FIG. 4 schematically illustrates an example bad block remapping table 256 of FIG. 2 in accordance with some embodiments of the present disclosure. In some embodiments, the program manager 134 generates one or more parameters that remap bad blocks. The program manager 134 may store the one or more parameters in the bad block remapping table 256. In some embodiments, the program manager 134 stores a block index in the bad block remapping table 256. A block index may identify each individual block of the memory array 250. For example, the program manager may store an index corresponding to block 360, block 361, block 362, block 363, and so on, etc. In some embodiments, the program manager 134 stores an address associated with each block (e.g., address 360a, address 361a, address 362a, address 363a, etc.). In some embodiments, each address may identify a location of the associated block. For example, the address may specify the physical address (e.g., die, plane, etc.) of the associated block in the memory array 250. In some embodiments, the physical block address is indicated by a location parameter.

The program manager may save one or more parameters associated with the source and destination for remapping bad blocks. For example, a source parameter identifying the block stripe to which the bad block was initially a part of may be generated and/or stored. Similarly, a destination parameter identifying the block stripe to which the bad block is remapped may be generated and/or stored. In some embodiments, the program manager 134 stores a block source parameter in the bad block remapping table 256. The block source parameter may identify the initial block stripe to which the bad block was assigned (e.g., block stripe 360b, block stripe 361b, block stripe 362b, block stripe 363b, etc.). The source parameter can be used to dissociate the bad block from the source block stripe for executing read and/or write operations. Similarly, in some embodiments, the program manager 134 stores a block destination parameter in the bad block remapping table 256. The block destination parameter may identify a block stripe to which the bad block is remapped (e.g., block stripe 360c, block stripe 361c, block stripe 362c, block stripe 363c, etc.). The destination parameter can be used to associate the bad block with the destination block stripe for executing read and/or write operations. In some embodiments, the block stripe to which the bad block is remapped is different from the initial block stripe. For example, block stripe 360b is different from block stripe 360c. Processing logic may refer to the bad block remapping table 256 when performing operations such as write operations or read operations. In some embodiments, the bad block remapping table 256 can be included on the memory device (e.g., the memory device 130 in FIG. 1A).

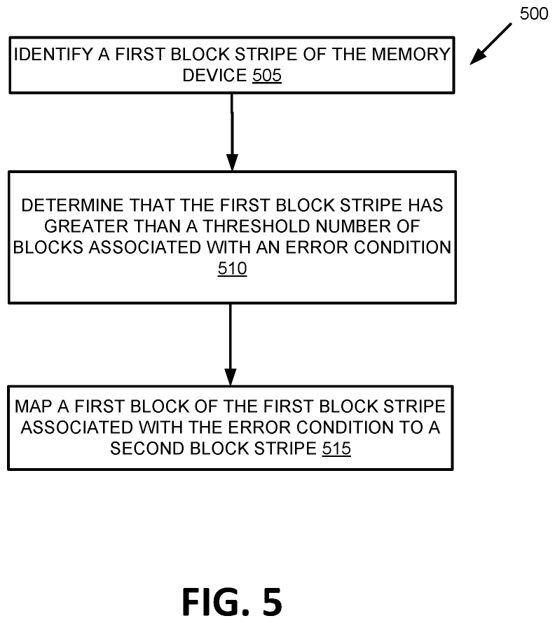

FIG. 5 is a flow diagram of an example method 500 to remap bad blocks in a memory sub-system in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the program manager 134 of FIGS. 1A and 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. In some embodiments, method 500 can occur during the low level formatting of the memory device (e.g., memory device 130 of FIGS. 1A, 1B, and 2).

At operation 505, the processing logic identifies a first block stripe of a memory device including multiple memory planes (e.g., memory device 130). The first block stripe can be identified by identifying multiple blocks across the memory planes and treating the blocks as a single unit. Each block can reside on a plane of the multiple memory planes. As an example illustrated in FIG. 3, block stripe 363 includes block 382D of plane0 372(0), block 383D of plane1 372(1), block 384D of plane2 372(2), and block 385D of plane3 372(3). To identify the first block stripe, the first block stripe may be scanned to determine whether each block of the first block stripe is associated with an error condition. For example, the processing logic scans the first block stripe for bad blocks (e.g., memory blocks having a BER above or below a threshold, memory blocks that are not fully or properly erased, memory blocks from which data cannot be read, etc.).

At operation 510, the processing logic determines that the first block stripe has greater than a threshold number of blocks associated with an error condition (e.g., greater than a threshold number of bad blocks). For example, the processing logic determines that the first block stripe has more than the threshold number of bad blocks as the result of a scanning operation (e.g., scanning for bad blocks). The threshold number of bad blocks may be determined based on a ratio of the total number of bad blocks on the memory device (e.g., the LUN) to the number of block stripes on the memory device.

At operation 515, responsive to determining that the first block stripe has greater than the threshold number of bad blocks, the processing logic maps a first block of the first block stripe (e.g., a first bad block) to a second block stripe. The second block stripe may have fewer than the threshold number of bad blocks. In some examples, mapping the first block (e.g., the bad block) from the first block stripe to the second block stripe reduces the number of bad blocks in the first block stripe while increasing the number of bad blocks in the second block stripe. By remapping one or more bad blocks from the first block stripe to the second block stripe, the bad blocks may be more evenly distributed amongst the block stripes.

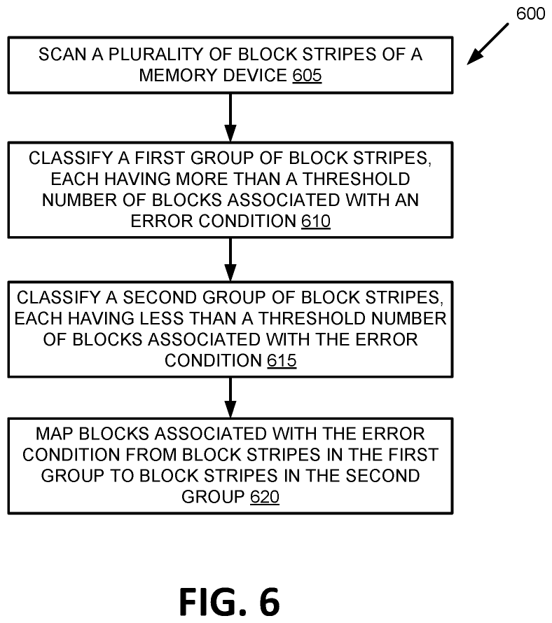

FIG. 6 is a flow diagram of an example method 600 to remap bad blocks in a memory sub-system, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the program manager 134 of FIGS. 1A and 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. In some embodiments, method 600 can occur during the low level formatting of the memory device (e.g., memory device 130 of FIGS. 1A, 1B, and 2).

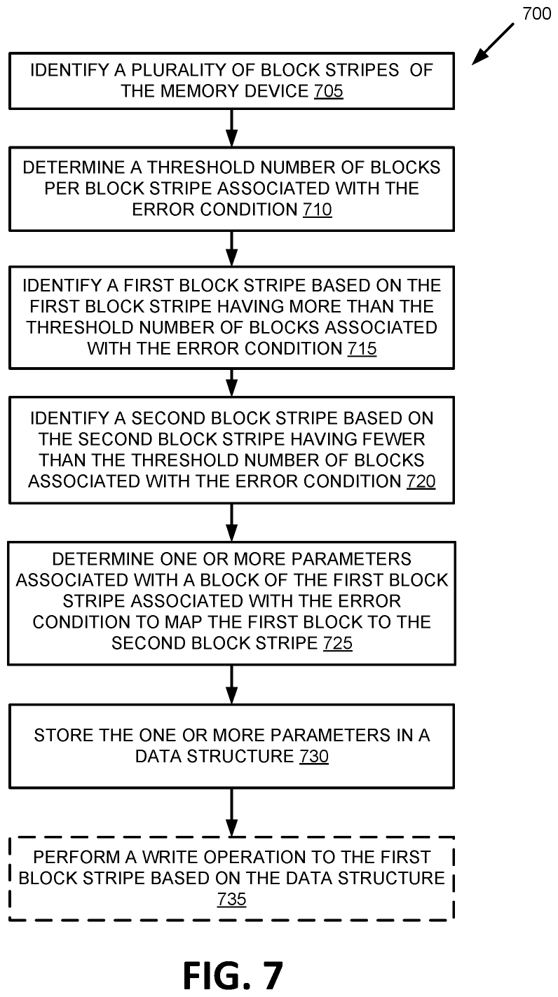

At operation 605, processing logic scans a plurality of block stripes of a memory device. The plurality of block stripes may include a first block stripe having more than a threshold number of bad blocks and a second block stripe having fewer than the threshold number of bad blocks. Each of the first block stripe and the second block stripe may be scanned to determine whether each has more or fewer than the threshold number of bad blocks. The threshold number can be calculated using a ratio of the total number of bad blocks to the total number of block stripes (e.g., bad blocks÷block stripes) as explained below. In some embodiments, the threshold number may be the next integer value less than the value of the ratio. For example, where there are 88 bad blocks in a memory system and 30 block stripes, the ratio may have a value of approximately 2.93 (e.g., 88÷30=2.933). In such an example, the threshold number is two (e.g., the next integer value less than 2.93). In some embodiments, the threshold number may be the next integer value greater than the value of the ratio. In an example where there are 88 bad blocks and 30 block stripes, the ratio has a value of approximately 2.93. The threshold number can be three (e.g., the next integer value greater than 2.93). More details regarding the determination of the threshold number are explained below with reference to operation 710 of FIG. 7.

At operation 610, processing logic classifies a first group of block stripes. The first group may be made up of block stripes that each have more than the threshold number of blocks associated with an error condition (e.g., Group A). For example, based on the scanning performed at operation 605, the processing logic classifies block stripes having more than the threshold number of bad blocks into a first group of block stripes. In the latter example laid out with reference to operation 605, the processing logic classifies block stripes having more than three bad blocks to a first group (e.g., Group A). In some embodiments, the block stripes of the first group (e.g., Group A) have varying amounts of bad blocks in excess of the threshold number. Continuing with the above example, each block stripe of the first group may include more than three bad blocks.

At operation 615, processing logic classifies a second group of block stripes. The second group may be made up of block stripes that each have fewer than the threshold number of blocks associated with the error condition (e.g., Group B). For example, based on the scanning performed at operation 605, the processing logic classifies block stripes having less than the threshold number of bad blocks into a second group of block stripes. Continuing with the latter example laid out with reference to operation 605 and described further with reference to operation 610, the processing logic classifies block stripes having less than three bad blocks to a second group (e.g., Group B). In some embodiments, the block stripes of the second group (e.g., group B) have varying amounts of bad blocks less than the threshold number. Some block stripes classified in the second group may have zero bad blocks. Continuing with the above example, each block stripe of the second group may have fewer than three bad blocks. In some embodiments, a third group of block stripes is classified by the processing logic. The third group (e.g., Group C) may include block stripes having the threshold number of bad blocks.

At operation 620, processing logic maps blocks associated with the error condition from block stripes in the first group to block stripes in the second group. For example, the processing logic may remap (e.g., reassign) bad blocks from block stripes in Group A to block stripes in Group B. In some embodiments, the processing logic quantifies the number of bad blocks each block stripe in Group A has in excess of the threshold number. Similarly, the processing logic may quantify the number of bad blocks each block stripe in Group B has in deficit of the threshold number. The processing logic may generate remapping parameters to store in a remapping table (e.g., bad block remapping table 256 of FIGS. 2 and 4) to remap the bad blocks. In some embodiments, bad blocks are remapped from each of the block stripes in Group A to block stripes in Group B such that each block stripe of the memory device (e.g., of one or more LUNs) has the threshold number of bad blocks. In implementations where the number of bad blocks is not evenly divisible by the number of block stripes, the bad blocks may be remapped from Group A block stripes to Group B block stripes such that each block stripe has the threshold number of bad blocks plus or minus one (e.g., the threshold number, one greater than the threshold number, or one less than the threshold number, etc.). For example, where the threshold number is three and there are ten bad blocks across four block stripes, the bad blocks may be remapped between Group A and Group B such that two block stripes have three bad blocks and two block stripes have two bad blocks.

FIG. 7 is a flow diagram of an example method 700 to remap bad blocks in a memory sub-system, in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the program manager 134 of FIGS. 1A and 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. In some embodiments, method 700 (excluding operation 735) can occur during the low level formatting of the memory device (e.g., memory device 130 of FIGS. 1A, 1B, and 2).

At operation 705, the processing logic identifies a plurality of block stripes of a memory device including a plurality of memory planes (e.g., memory device 130). The plurality of block stripes can be identified by identifying multiple blocks across the memory planes and treating the blocks as a single unit. Each block can reside on a plane of the plurality of memory planes.

At operation 710, the processing logic determines a threshold number of blocks per block stripe associated with an error condition (e.g., a threshold number of bad blocks). In some embodiments, the threshold number of blocks is determined using a ratio of a total number of blocks associated with the error condition across the plurality of memory planes to a total number of block stripes (e.g., bad blocks:block stripes).

At operation 715, processing logic identifies a first block stripe from the plurality of block stripes having more than the threshold number of blocks associated with the error condition. For example, the processing logic may identify a first block stripe having more than the threshold number of bad blocks. In some embodiments, multiple block stripes are identified as having more than the threshold number of bad blocks. Such identified block stripes may be classified into a first group. In some embodiments, the processing logic determines an excess margin corresponding to the first block stripe. In some embodiments, the excess margin corresponds to how many bad blocks the first block stripe has greater than the threshold number of blocks. For example, if the threshold number of blocks is four and the first block stripe has five bad blocks, the excess margin is one (e.g., 5−4=1).

At operation 720, the processing logic identifies a second block stripe from the plurality of block stripes having fewer than the threshold number of blocks associated with the error condition. For example, the processing logic may identify a second block stripe having fewer than the threshold number of bad blocks. In some embodiments, multiple block stripes are identified as having fewer than the threshold number of bad blocks. Such identified block stripes may be classified into a second group. In some embodiments, the processing logic determines a deficit margin corresponding to the second block stripe. In some embodiments, the deficit margin corresponds to how many bad blocks the second block stripe has less than the threshold number of blocks. For example, if the threshold number of blocks is 2 and the second block stripe has zero bad blocks, the deficit margin is 2 (e.g., 2−0=2).

At operation 725, processing logic determines one or more parameters associated with a first block of the first block stripe to map the first block to the second block stripe. The one or more parameters may include location parameters, source parameter, destination parameters, physical address parameters, and/or other identifying metadata, etc. The first block may be associated with the error condition (e.g., the first block may be a bad block). In some embodiments, the one or more parameters include a block stripe index parameter, an origination parameter, and/or a location parameter as described herein above.

In some embodiments, the one or more parameters mapping the first block to the second block stripe are generated using an iterative process. The processing logic may iteratively map bad blocks from block stripes of the first group to the block stripes of the second group. For example, beginning with the first block stripe of the first group, the processing logic may map one or more bad blocks (e.g., corresponding to the excess margin determined at operation 715) to one or more block stripes of the second group (e.g., having fewer than the threshold number of bad blocks). The processing logic may verify that a second block stripe of the second group has fewer than the threshold number of bad blocks before mapping the first block to the second block stripe. Bad blocks can be mapped to the second block stripe until the second block stripe has the threshold number of bad blocks (e.g., until the deficit margin number of bad blocks determined at operation 720 have been mapped to the second block stripe). Once the second block stripe has the threshold number of bad blocks (e.g., once enough bad blocks have been mapped to the second block stripe so that the second block stripe has the threshold number of bad blocks), the processing logic may map bad blocks to the next block stripe of the second group. After each of the bad blocks in excess of the threshold number have been mapped from the first block stripe, processing logic may map one or more bad blocks from the next block stripe in the first group to one or more block stripes of the second group. This process of mapping bad blocks from block stripes of the first group to block stripes of the second group may continue until all block stripes have the threshold number of bad blocks, plus or minus one. The one or more parameters described above may be generated to map the bad blocks of first group block stripes to the second group block stripes.

At operation 730, processing logic stores the one or more parameters in a data structure (e.g., bad block remapping table 256). The data structure may be stored on the memory device in some embodiments.

At operation 735, processing logic uses the data structure to perform a write operation to the first block stripe. For example, the processing logic utilizes the remapping parameters stored in the data structure for writing data to the first block stripe. The remapping parameters may indicate to the processing logic which blocks have been remapped from one block stripe to another. The remapping parameters can indicate to the processing logic that a specific block is not to be treated as a part of a particular block stripe, instead that the specific block is to be treated as a part of another block stripe. In some embodiments, the write operation is performed with respect to the first block stripe and/or to the second block stripe, etc.

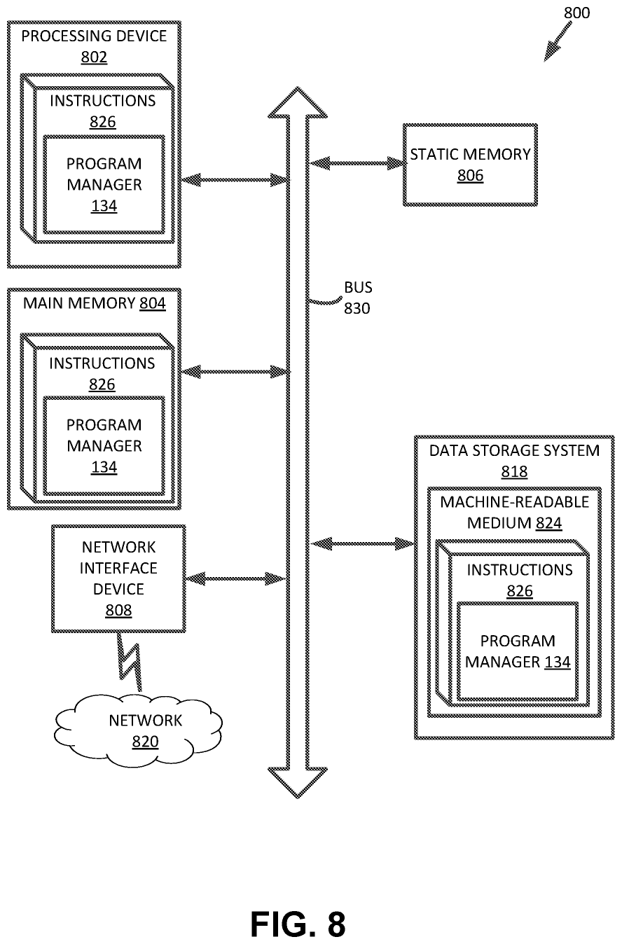

FIG. 8 illustrates an example machine of a computer system 800 within which a set of instructions, for causing the machine to perform any one or more of the methodologies discussed herein, can be executed. In some embodiments, the computer system 800 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to program manager 134 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or RDRAM, etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a non-transitory machine-readable storage medium 824 (also known as a non-transitory computer-readable storage medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1A.

In one embodiment, the instructions 826 include instructions to implement functionality corresponding to a program manager component (e.g., the program manager 134 of FIG. 1A). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device comprising a plurality of memory planes; and
a processing device, operatively coupled with the memory device, to perform operations comprising:
identifying a first block stripe of the memory device, wherein the first block stripe comprises a first plurality of blocks arranged across the plurality of memory planes;
determining that the first plurality of blocks of the first block stripe has greater than a threshold number of blocks associated with an error condition; and
responsive to determining that the first plurality of blocks has greater than the threshold number of blocks associated with the error condition, mapping a first block of the first plurality of blocks associated with the error condition to a second block stripe comprising a second plurality of blocks having fewer than the threshold number of blocks associated with the error condition.

2. The system of claim 1, wherein mapping the first block of the first plurality of blocks of the first block stripe to the second block stripe comprises:
determining the threshold number of blocks associated with the error condition, wherein the determining is based on a ratio of a total number of blocks associated with the error condition across the plurality of memory planes to a total number of block stripes across the plurality of memory planes;
identifying the second block stripe having fewer than the threshold number of blocks associated with the error condition; and
determining one or more parameters associated with the first block that map the first block to the second block stripe.

3. The system of claim 2, wherein the one or more parameters comprise one or more of:
a block stripe index parameter identifying the first block as having been mapped to the second block stripe;
an origination parameter identifying the first block as initially belonging to the first block stripe; or
a location parameter identifying a location of the first block in the plurality of memory planes.

4. The system of claim 1, wherein determining that the first plurality of blocks of the first block stripe has greater than the threshold number of blocks associated with the error condition comprises:
scanning a plurality of block stripes of the memory device, wherein the plurality of block stripes comprises the first block stripe and the second block stripe;
classifying a first group of block stripes of the plurality of block stripes, wherein each block stripe of the first group of block stripes comprises more than the threshold number of blocks associated with the error condition, and wherein the first group further comprises the first block stripe; and
classifying a second group of block stripes of the plurality of block stripes, wherein each block stripe of the second group of block stripes comprises less than the threshold number of blocks associated with the error condition, and wherein the second group further comprises the second block stripe.

5. The system of claim 1, wherein the processing device is to perform further operations comprising:
determining an excess margin corresponding to the first block stripe, wherein the excess margin corresponds to a first number of blocks greater than the threshold number of blocks, and wherein the first number of blocks are associated with the error condition; and
determining a deficit margin corresponding to the second block stripe, wherein the deficit margin corresponds to a second number of blocks less than the threshold number of blocks, and wherein the second number of blocks are associated with the error condition.

6. The system of claim 1, wherein the processing device is to perform further operations comprising:
storing, in a data structure, one or more parameters associated with mapping the first block to the second block stripe; and
performing a write operation to the first block stripe based on the one or more parameters stored in the data structure.

7. The system of claim 1, wherein identifying the first block stripe of the memory device comprises:
performing a scan of the plurality of memory planes of the memory device;
selecting a skew offset for the first block stripe based on the scan; and
mapping the first plurality of blocks across the plurality of memory planes to the first block stripe based on the skew offset.

8. The system of claim 1, wherein the processing device is to perform further operations comprising:
mapping a second block of the first plurality of blocks associated with the error condition to a third block stripe comprising a third plurality of blocks having fewer than the threshold number of blocks associated with the error condition.

9. A method comprising:
identifying a first block stripe of a memory device, wherein the first block stripe comprises a first plurality of blocks arranged across a plurality of memory planes of the memory device;
determining that the first plurality of blocks of the first block stripe has greater than a threshold number of blocks associated with an error condition; and
responsive to determining that the first plurality of blocks has greater than the threshold number of blocks associated with the error condition, mapping a first block of the first plurality of blocks associated with the error condition to a second block stripe comprising a second plurality of blocks having fewer than the threshold number of blocks associated with the error condition.

10. The method of claim 9, wherein mapping the first block of the first plurality of blocks of the first block stripe to the second block stripe comprises:
determining the threshold number of blocks associated with the error condition, wherein the determining is based on a ratio of a total number of blocks associated with the error condition across the plurality of memory planes to a total number of block stripes across the plurality of memory planes;
identifying the second block stripe having fewer than the threshold number of blocks associated with the error condition; and
determining one or more parameters associated with the first block that map the first block to the second block stripe.

11. The method of claim 9, wherein determining that the first plurality of blocks of the first block stripe has greater than the threshold number of blocks associated with the error condition comprises:
scanning a plurality of block stripes of the memory device, wherein the plurality of block stripes comprises the first block stripe and the second block stripe;
classifying a first group of block stripes of the plurality of block stripes, wherein each block stripe of the first group of block stripes comprises more than the threshold number of blocks associated with the error condition, and wherein the first group further comprises the first block stripe; and
classifying a second group of block stripes of the plurality of block stripes, wherein each block stripe of the second group of block stripes comprises less than the threshold number of blocks associated with the error condition, and wherein the second group further comprises the second block stripe.

12. The method of claim 9, further comprising:
determining an excess margin corresponding to the first block stripe, wherein the excess margin corresponds to a first number of blocks greater than the threshold number of blocks, and wherein the first number of blocks are associated with the error condition; and
determining a deficit margin corresponding to the second block stripe, wherein the deficit margin corresponds to a second number of blocks less than the threshold number of blocks, and wherein the second number of blocks are associated with the error condition.

13. The method of claim 9, further comprising:
storing, in a data structure, one or more parameters associated with mapping the first block to the second block stripe; and
performing a write operation to the first block stripe based on the one or more parameters stored in the data structure.

14. The method of claim 9, wherein identifying the first block stripe of the memory device comprises:
performing a scan of the plurality of memory planes of the memory device;
selecting a skew offset for the first block stripe based on the scan; and
mapping the first plurality of blocks across the plurality of memory planes to the first block stripe based on the skew offset.

15. The method of claim 9, further comprising:
mapping a second block of the first plurality of blocks associated with the error condition to a third block stripe comprising a third plurality of blocks having fewer than the threshold number of blocks associated with the error condition.

16. A non-transitory computer-readable storage medium comprising instructions that, when executed by a processing device, cause the processing device to perform operations comprising:
identifying a first block stripe of a memory device, wherein the first block stripe comprises a first plurality of blocks arranged across a plurality of memory planes of the memory device;
determining that the first plurality of blocks of the first block stripe has greater than a threshold number of blocks associated with an error condition; and
responsive to determining that the first plurality of blocks has greater than the threshold number of blocks associated with the error condition, mapping a first block of the first plurality of blocks associated with the error condition to a second block stripe comprising a second plurality of blocks having fewer than the threshold number of blocks associated with the error condition.

17. The non-transitory computer-readable storage medium of claim 16, wherein mapping the first block of the first plurality of blocks of the first block stripe to the second block stripe comprises:
determining the threshold number of blocks associated with the error condition, wherein the determining is based on a ratio of a total number of blocks associated with the error condition across the plurality of memory planes to a total number of block stripes across the plurality of memory planes;
identifying the second block stripe having fewer than the threshold number of blocks associated with the error condition; and
determining one or more parameters associated with the first block that map the first block to the second block stripe.

18. The non-transitory computer-readable storage medium of claim 16, wherein determining that the first plurality of blocks of the first block stripe has greater than the threshold number of blocks associated with the error condition comprises:
scanning a plurality of block stripes of the memory device, wherein the plurality of block stripes comprises the first block stripe and the second block stripe;
classifying a first group of block stripes of the plurality of block stripes, wherein each block stripe of the first group of block stripes comprises more than the threshold number of blocks associated with the error condition, and wherein the first group further comprises the first block stripe; and
classifying a second group of block stripes of the plurality of block stripes, wherein each block stripe of the second group of block stripes comprises less than the threshold number of blocks associated with the error condition, and wherein the second group further comprises the second block stripe.

19. The non-transitory computer-readable storage medium of claim 16, wherein the processing device is to perform further operations comprising:
storing, in a data structure, one or more parameters associated with mapping the first block to the second block stripe; and
performing a write operation to the first block stripe based on the one or more parameters stored in the data structure.

20. The non-transitory computer-readable storage medium of claim 16, wherein the processing device is to perform further operations comprising:
mapping a second block of the first plurality of blocks associated with the error condition to a third block stripe comprising a third plurality of blocks having fewer than the threshold number of blocks associated with the error condition.
